(19) United States
(12) Patent Application Publication
(10) Pub. No.: US 2003/0142797 A1
(43) Pub. Date: Jul. 31, 2003

(54) Information notification system

(76) Inventors: Terrence E. Troy, St. Paul, MN (US); Terrance R. Halsch, Hopkins, MN (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/320,169

(22) Filed: Dec. 16, 2002

Related U.S. Application Data
(60) Provisional application No. 60/341,420, filed on Dec. 17, 2001.

(51) Int. Cl. H04M 1/64

(52) U.S. Cl. 379/88.12

(57) ABSTRACT

A method for sending a message from a sender to a receiver may begin with the sender choosing what type of message to create. The message may then be created in a format matching the type of message chosen. If desired, the sender may choose one or more groups to receive the message. If desired, the sender may also choose one or more communication channels to use in distributing the information. Once the sender chooses a geographic coverage area, the message is distributed to the proper recipients. The message may be stored in a database for later retrieval.

### CROSS-REFERENCE TO RELATED APPLICATION

This application claims the benefit of U.S. Provisional Application No. s60/341,420, filed Dec. 17, 2001, the contents of which are incorporated by reference.

### BACKGROUND OF THE INVENTION

The present invention relates to an informational system, and more particularly to a website and other channel portal through which safety notifications can be posted, distributed, viewed, and discussed. According to the Federal Bureau of Investigations, in the year 2001 there were 11,849,006 “Crime Index offenses” in the United States. Crime Index offenses include the violent crimes of murder and non-negligent manslaughter, forcible rape, robbery, and aggravated assault, and the property crimes of burglary, larceny-theft, and motor vehicle theft. In addition, there are more than 58,000 children in the United States abducted by non-family members each year, according to the October 2002 White House Conference on Missing, Exploited and Runaway Children.

Clearly, investigating such a large number crimes and missing person cases is an enormous task. Handling these investigations is a plethora of law enforcement agencies, including city police departments, county sheriff offices, state police and highway patrol divisions, state bureaus of investigation, and federal agencies such as the Drug Enforcement Administration and the Federal Bureau of Investigation. It is difficult for these law enforcement agencies to work together to share information about unsolved crimes, missing persons, etc. What is needed is a system that would collect crime and similar information, and then disseminate it to the various applicable agencies.

The law enforcement agencies and public safety departments are not the only ones concerned with crimes, missing persons, and fugitives. Family members of crime victims can themselves lead efforts to bring attention to the crime. Neighborhood watch groups and business groups (along with other types of affinity groups) can work together to prevent future crimes and to apprehend perpetrators of past ones. What is needed is an easy to use system that can be used by such groups to publicize their work and to alert groups of important crime and crime prevention information.

Past methods of disseminating information concerning crimes, missing persons, and fugitives have been marked by various disadvantages. Some systems post photos and descriptive information about criminal suspects on a website. However, such systems are passive—one must periodically go to the website and page through all of the photos to determine if any new postings are of interest. What is need is an active system of reporting new information. Furthermore, such a system should actively send the message to only proper people based on some categorization of groups.

Other systems are haphazard and unreliable. For example, some family members of crime victims have sent email messages to countless people requesting assistance in solving the crime. Recipients of the emails may in turn forward the information to others. While this process distributes the information in an active fashion, receivers of the email messages have no easy way to determine whether the message is legitimate or a hoax. Furthermore, the messages are sent to email addresses without regard for whether the recipient is located in the area where the crime took place or the fugitive may be hiding. What is needed is a system in which recipients of the crime alerts can be assured that the information is legitimate. What is also needed is a system for easily sending the information to people within a specified area.

In an attempt to solve this need, still other systems may allow a message to be sent to people in certain states, cities, etc. While this is an improvement over sending the message to an entire mailing list, it has its own shortcomings. For example, some crime information is of interest to a very limited geographic area, such as a neighborhood wanting to be informed of petty vandalism. Systems relying on city, state, or ZIP code information are incapable of distributing the information to such a limited area within the city. At the other end of the spectrum, certain crime information needs to be distributed to a wide area that has no handy geographic descriptor. For example, in the case of a missing child, law enforcement agencies may wish to alert people within a 250 mile radius of where the child was last seen. This area may encompass one or more cities, full and partial counties, portions of several states, etc. Again, a system set up to identify recipients based on city or ZIP is easy to manage, but lacks the ability to target messages effectively. What is needed is a system of distributing safety alerts and other messages to recipients within a geographic coverage area that may be defined by the sender.

Another disadvantage of present systems is their narrow use of communication methods. Some systems may only distribute messages via mail. Other systems may only use email. What is needed is a system that can distribute the information to recipients via any number of preferred communication channels selected by the sender or the receiver.

### SUMMARY OF THE INVENTION

A method for sending a message from a sender to a receiver may begin with the sender choosing what type of message to create. The message may then be created in a format matching the type of message chosen. If desired, the sender may choose one or more groups to receive the message. If desired, the sender may also choose one or more communication channels to use in distributing the information. Once the sender chooses a geographic coverage area, the message is distributed to the proper recipients. The message may be stored in a database for later retrieval.

It is one object of the invention to provide a public website as a public safety vehicle for finding and exchanging information and ideas among private citizens, community and civic groups, law enforcement agencies, public safety departments and educational facilities, in an attempt to prevent and to resolve crimes, to raise public awareness, to offer support to victims, and to create safer communities.

It is one object of the invention to share this information in an active fashion so that messages are distributed in a timely fashion to recipients without requiring those recipients to visit the website. However, it is one object of the invention to provide an easy way to ensure that the information is legitimate and is not a hoax by allowing the recipients to cross-check the information against an online database.

It is one object of the invention to target the distribution of the message to a geographic area that can be defined by a circle of given radius, a hand-traced region on a map, or by proximity to a landmark, neighborhood, or other form of descriptor.

It is one object of the invention to distribute the message to the appropriate set of recipients based on their membership in one or more predefined categories, such as a neighborhood watch group or a business chamber of commerce.

It is yet one more object of the invention to leverage many communication channels in distributing the messages, as decided by the sender and/or the recipients. The use of multiple channels ensures that the information is more readily available.

### BRIEF DESCRIPTION OF THE DRAWINGS

FIGS. 1 and 2 illustrate a webpage in which a notification message type is selected.

FIGS. 3 and 4 illustrate a webpage in which a crime alert is created.

FIGS. 5 through 7 illustrate a webpage in which a business alert is created.

FIGS. 8 through 11 illustrate a registration by a recipient.

FIG. 12 is a block diagram of one technical architecture for the invention.

FIG. 13 illustrates data entered for a business alert, using a variation of the template shown in FIGS. 5 through 7.

FIG. 14 illustrates the message in its distributed form.

### DETAILED DESCRIPTION OF THE INVENTION

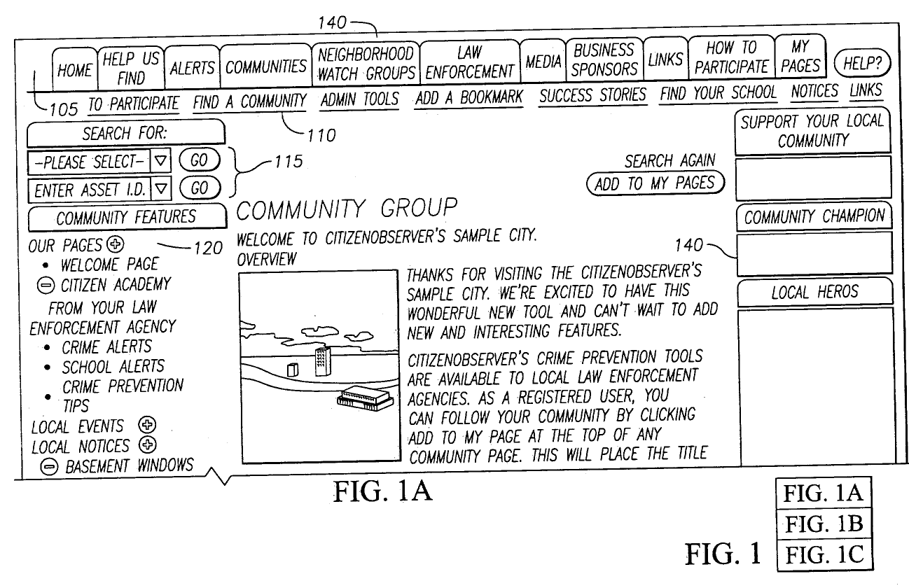

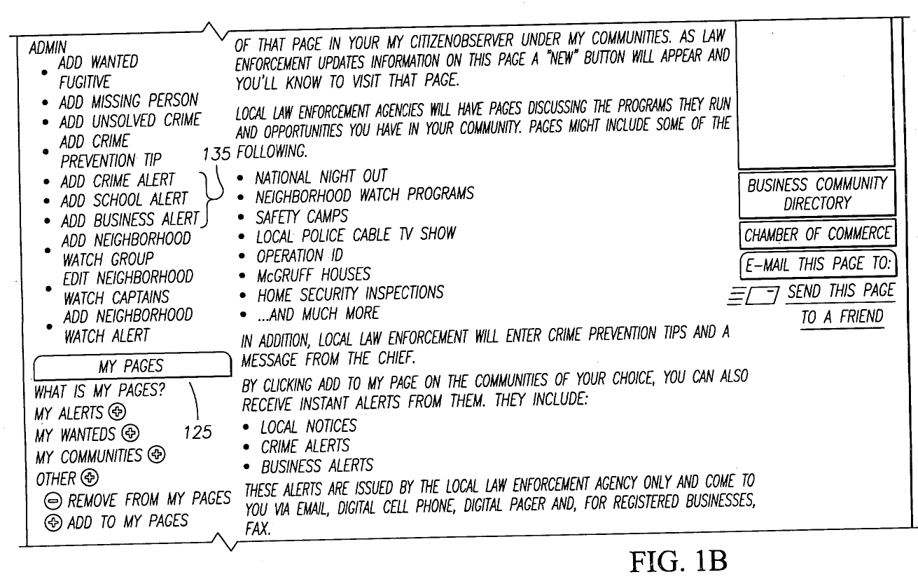

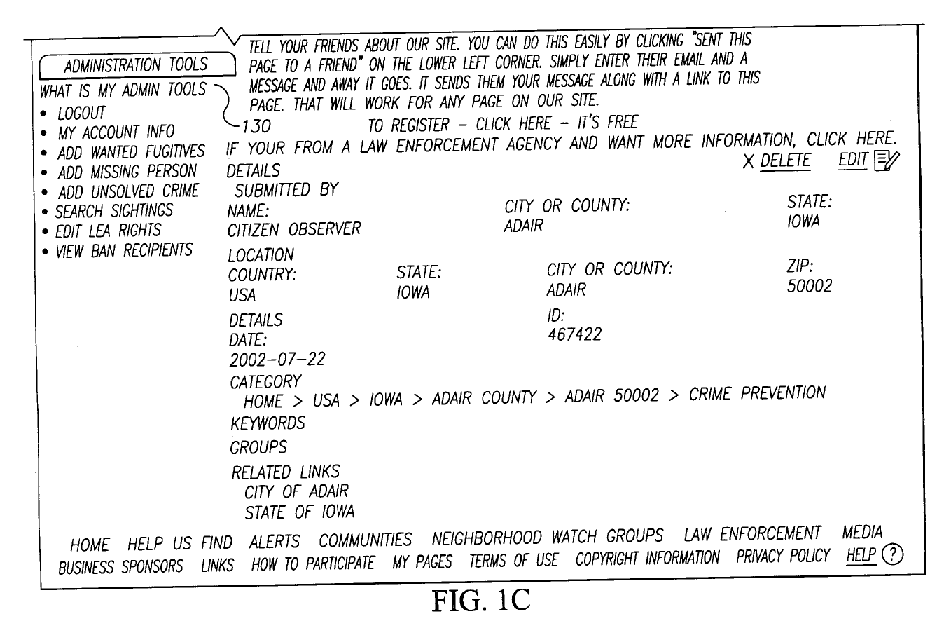

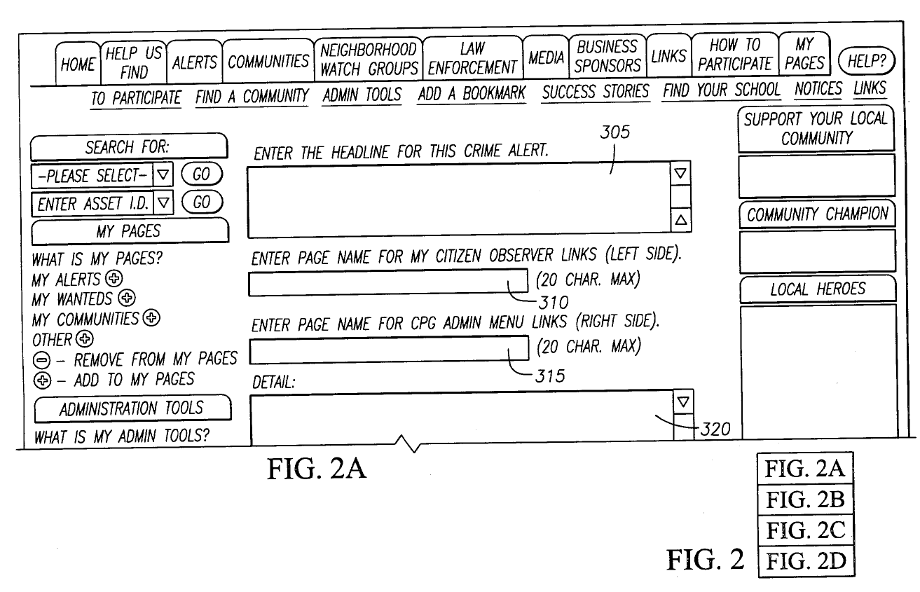

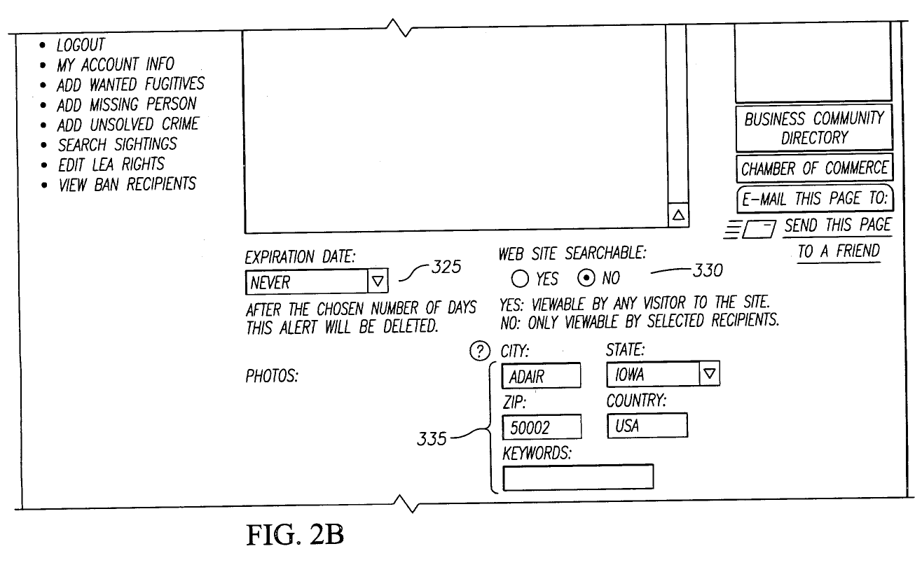

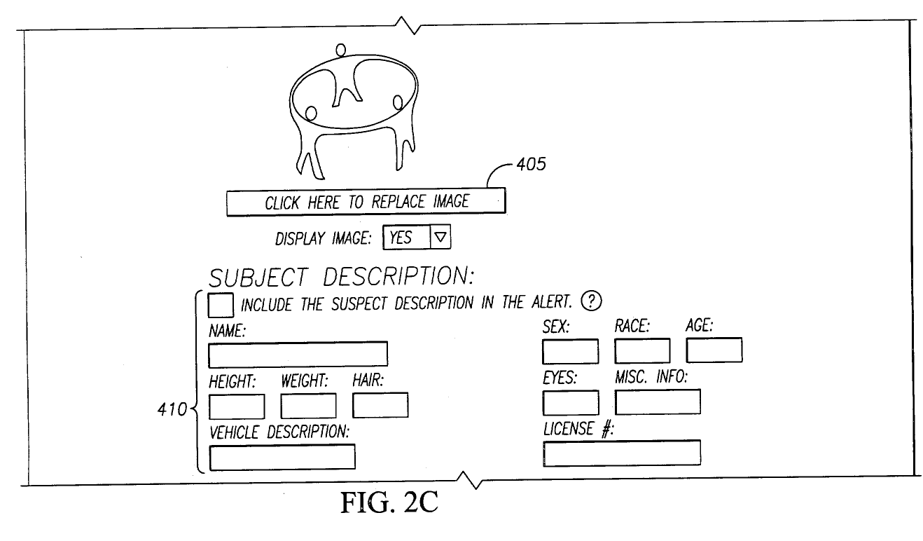

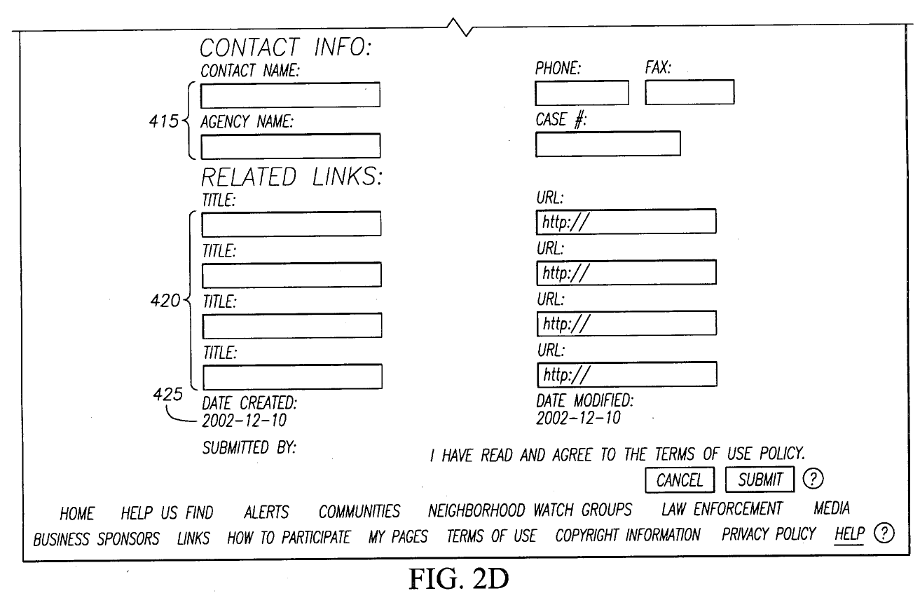

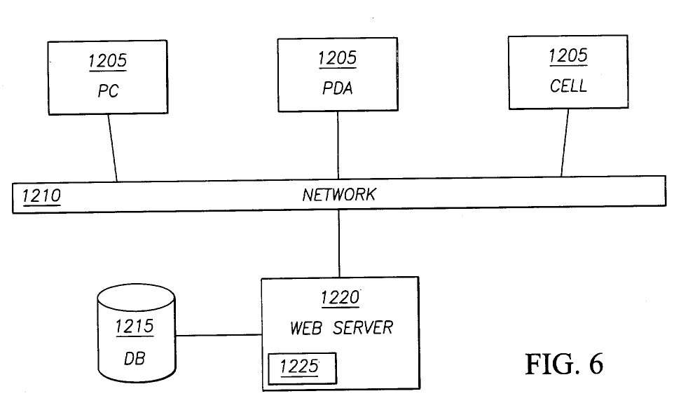

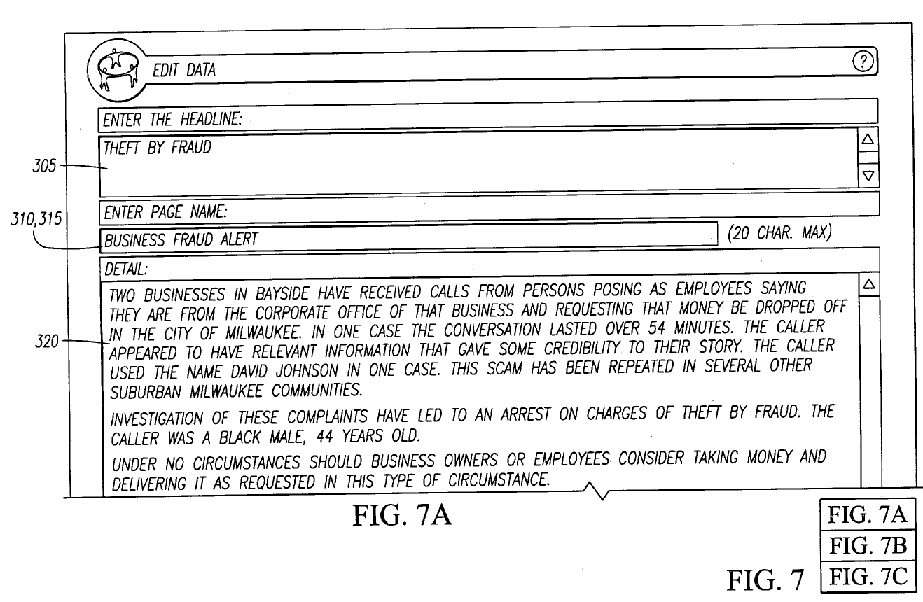

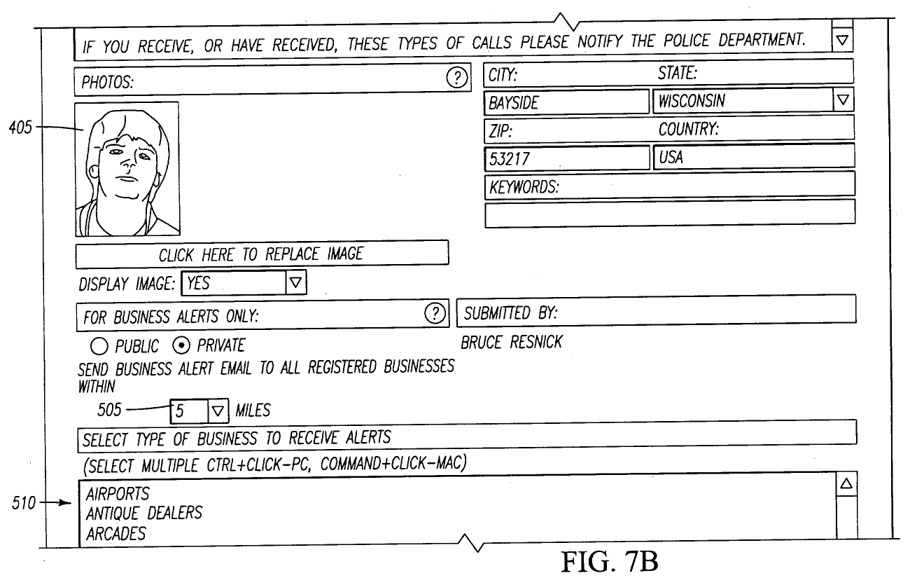

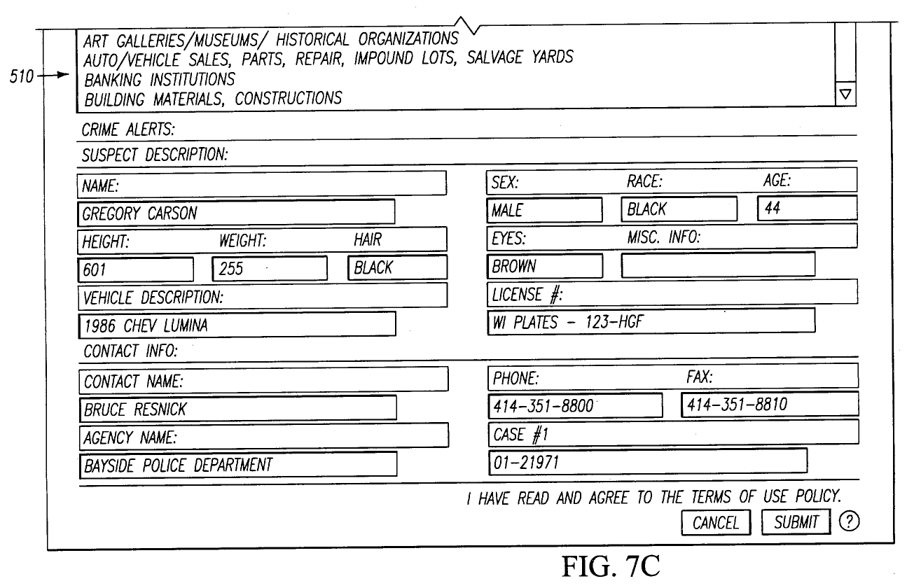

A central portion of the present invention is a portal (made up of a website and other channels) for finding and exchanging information and ideas among private citizens, community and civic groups, law enforcement agencies, public safety departments and educational facilities, in an attempt to prevent and to resolve crimes, to raise public awareness, and to offer support to victims. While the website can be fashioned in numerous ways, the FIGS. 1 through 14 show one preferred embodiment. FIGS. 1 and 2 illustrate a webpage of the website, having a series of tabs 105 and quick links 110. The tabs 105 allow the user to easily navigate the website. Along the left side of the webpage is a search function 115, a community features section 120, a personalized section 125, and a set of administration tools 130. There are also areas set aside for sponsored advertisements 140.

From the webpage illustrated in FIGS. 1 and 2, an authorized sender may choose which type of notification message to create. For example, the sender may wish to generate a crime alert 135.1, a school alert 135.2, or a business alert 135.3.

Users of the present invention's system fall into a variety of types. Some of these types can be authorized as senders. Others are only authorized to receive notices and/or to view a portion of the system. In one embodiment of the invention, users are assigned as: system administrators, law enforcement agent officers, public safety department leaders, group administrators (such as crime prevention group leaders, school district group leaders, etc.), advocates, business users, neighborhood captains, registered users, and non-registered users. Of course, additional categorization of users is possible. For example, in one embodiment, the receiver groups may be chosen from: sender enrolled, sender approved, sender allowed, self enrolled, group enrolled, and third party enrolled. Sender enrolled, sender approved and sender allowed receiver groups are predefined groups that the sender has identified as recipients who consistently receive similar notifications or who frequently receive notification messages. Examples of such groups may be Neighborhood Watch Captains and Members or members of a specific agency, department or organization or branch thereof. Self enrolled receivers are those who have requested to receive notifications without being included in a larger group of receivers. Group enrolled receivers are members who have been enrolled by a group to which they belong such as a Chamber of Commerce or other civic organization. Third Party enrolled receivers are receivers who have been enrolled as a result of their affiliation with a specific entity such as an employer.

Another form of categorization is directed to the type of notice. In one embodiment, notices may be crime alerts, school alerts, neighborhood alerts, business alerts, wanted fugitive alerts, missing persons information, unsolved crime notices, crime prevention tips, general notices, local events information, advocate information, crime statistics, safety catalog product information, etc.

Based on the user's categorization, only certain types of notices may be created, edited, and/or viewed by the user. For example, in one embodiment, while a registered user may view a crime alert, only the system administrator or a law enforcement agency officer may create a crime alert. Across the system's areas such restrictions of activities may be controlled through security measures. For example, notification messages stored on the database, message boards, chat rooms, webpages, teleconferences, video-conferences and the like can all be secured so that only authorized users are granted access to them.

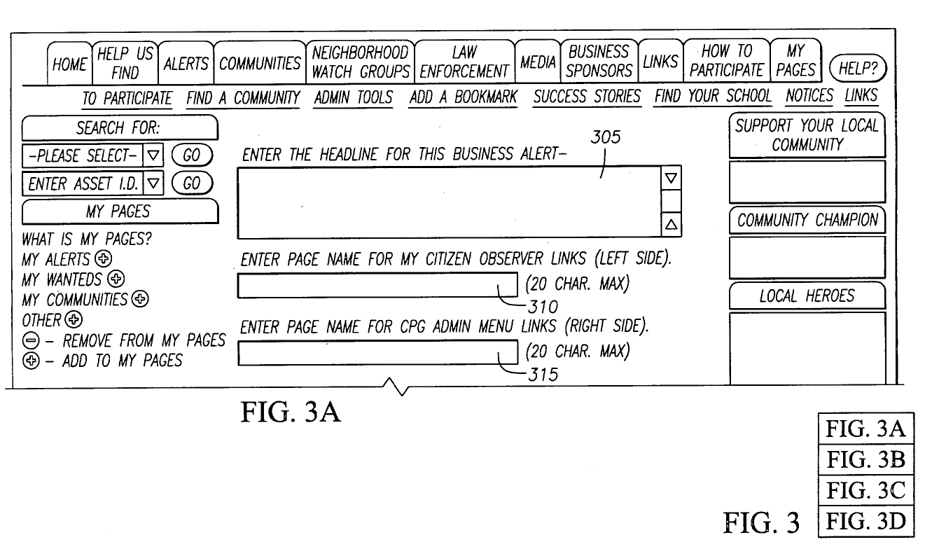

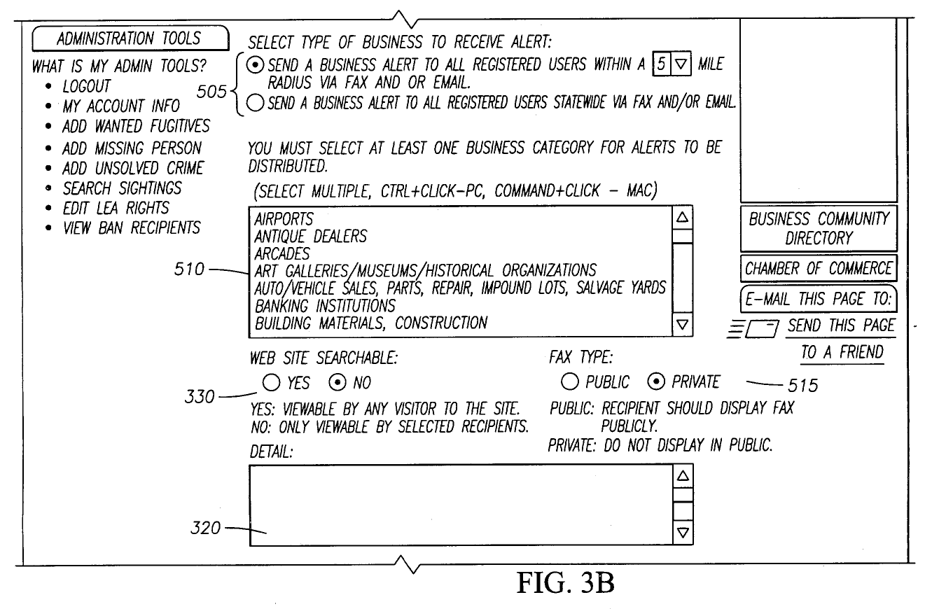

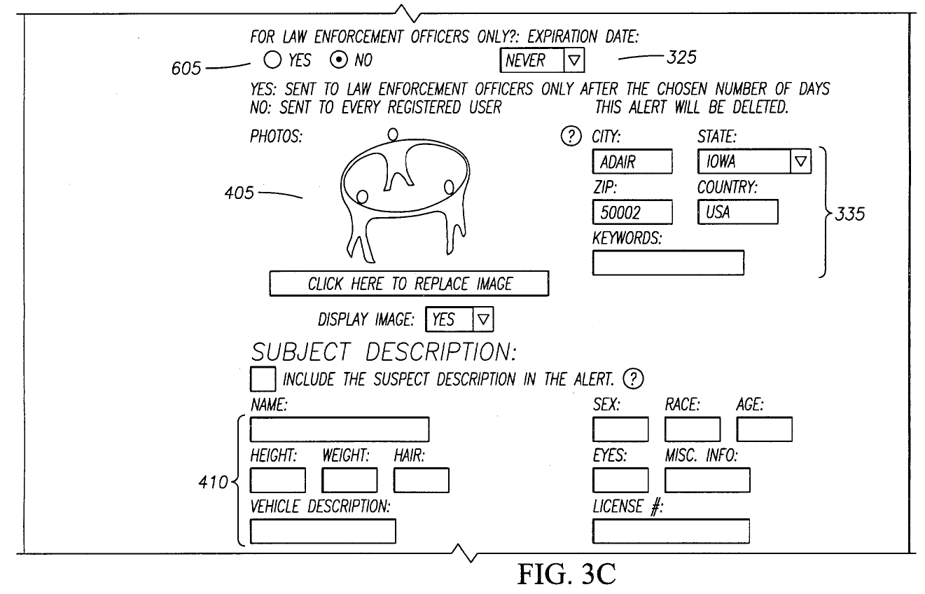

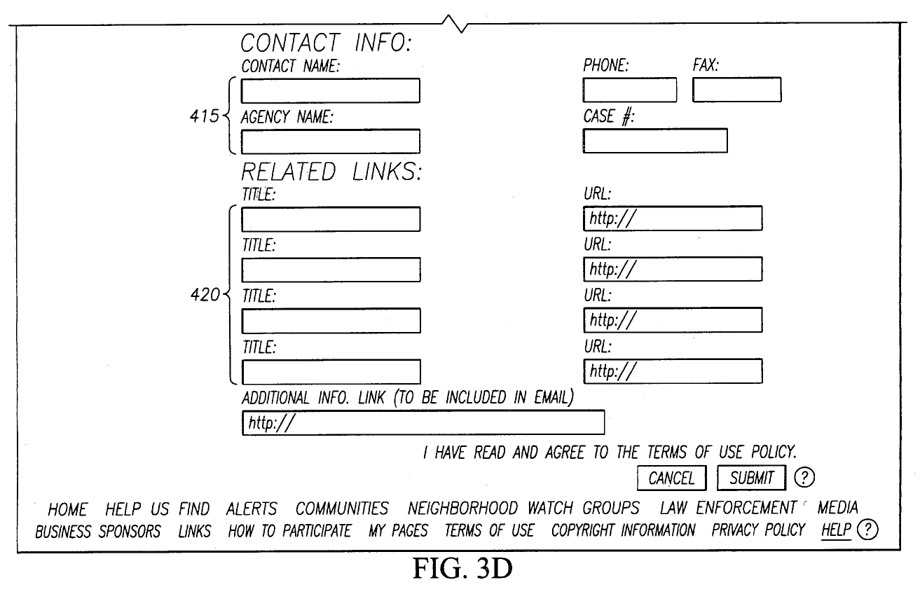

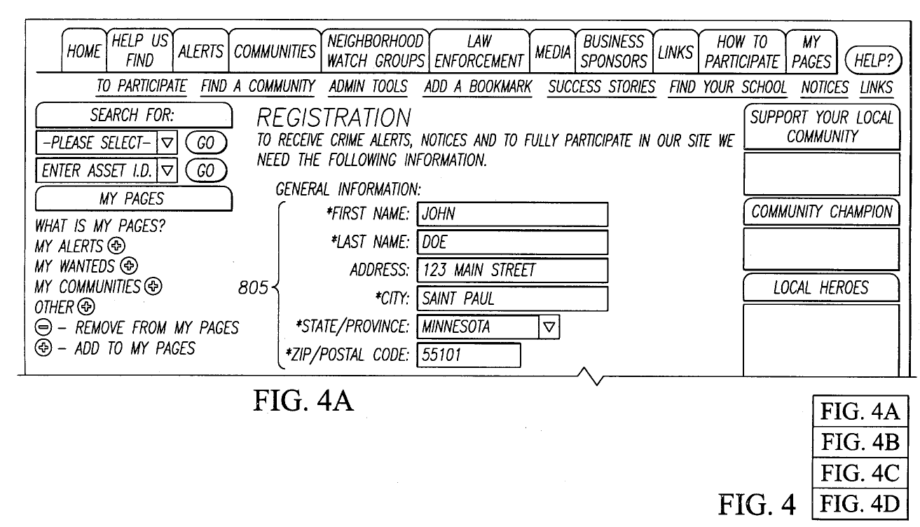

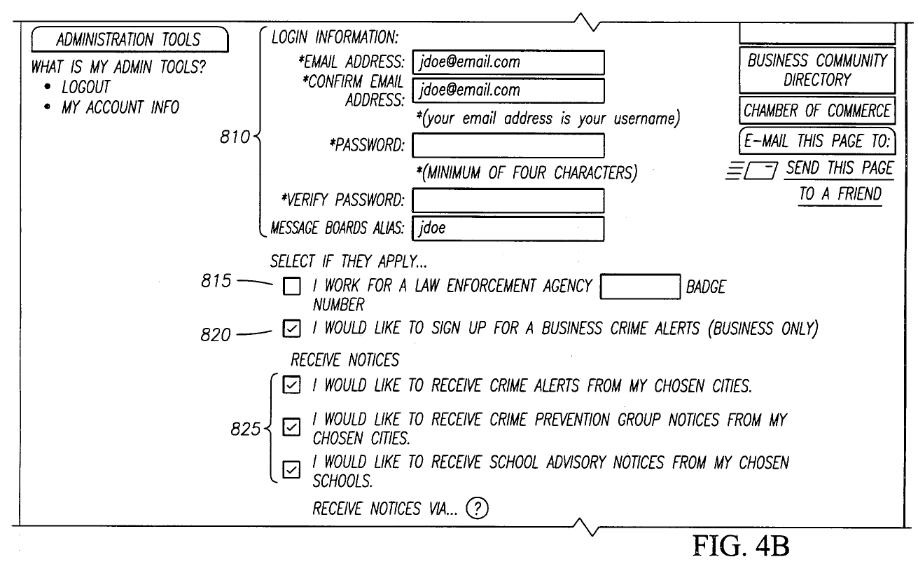

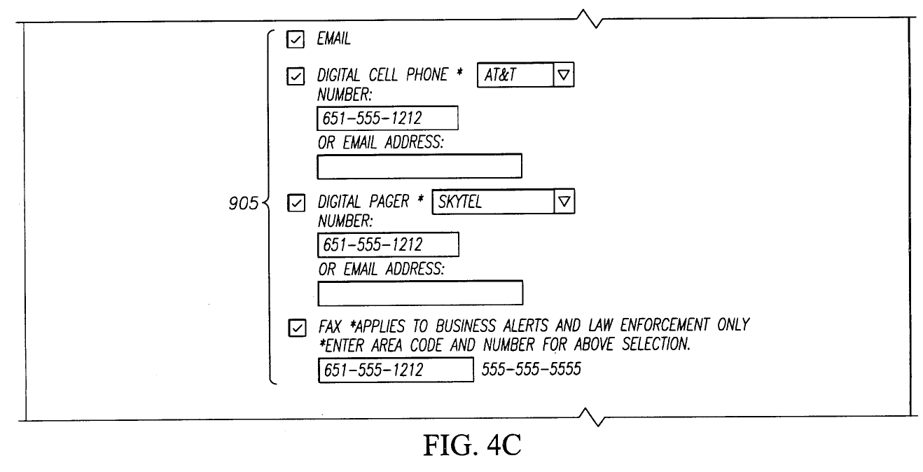

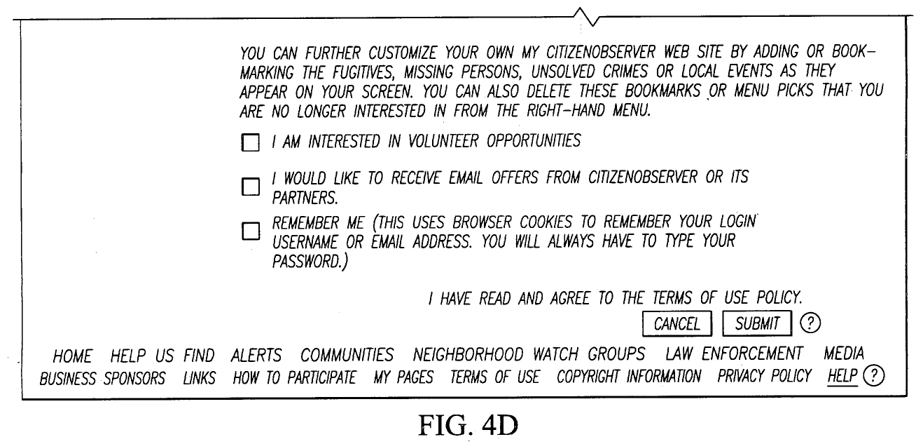

FIGS. 3 and 4 illustrate a webpage in which a crime alert is created. At the top of the webpage, the sender enters the headline to be associated with the crime alert 305. Next, page names to display under the “My Links” 315 and page names to display within the Crime Prevention Group section 315. There is a field provided for entry of the details of the crime alert 320 as well as a description of the suspect 410. The sender may customize the alert by choosing an expiration date 325 as well as whether the alert (as it is stored in the database) will be viewable by the public or only by certain persons 330. Furthermore, there is a section of the webpage in which the sender can enter the location of the crime and associated keywords 335 in order to make searching and distribution easier. For example, the distribution may be limited to receivers within the same ZIP code, the same city, etc. In some embodiments, the template allows for another type of geographic descriptor to be entered, such as a neighborhood name, a local landmark, a school name, etc. Or, some systems allow the geographic limitation to be implemented through a receiver group.

A photo or other image may be loaded through the webpage 405 and information on who the recipient should contact is also entered 415. Finally, the sender has an area to enter one or more URLs and associated titles 420. This will allow the recipient to link to an appropriate website for more information. Such websites may be maintained by a victim advocate or neighborhood watch group. The system may require that the website be explicitly authorized by the sender.

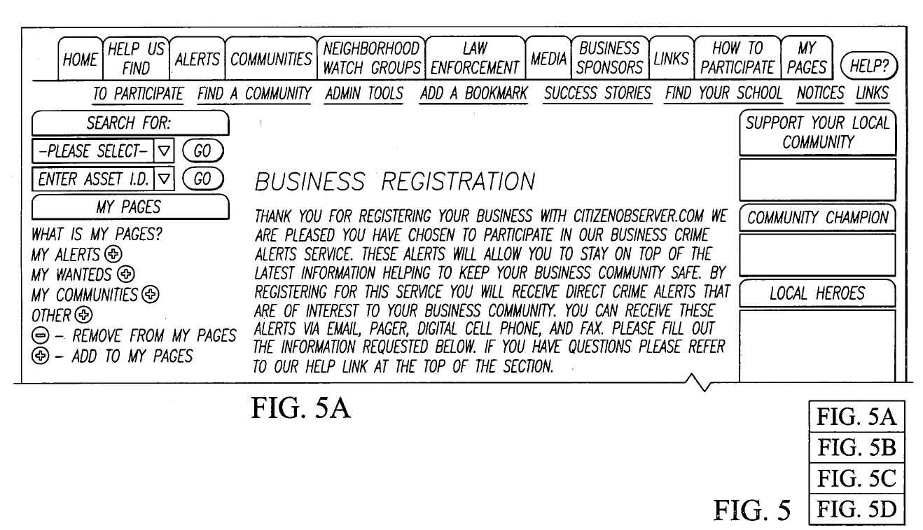

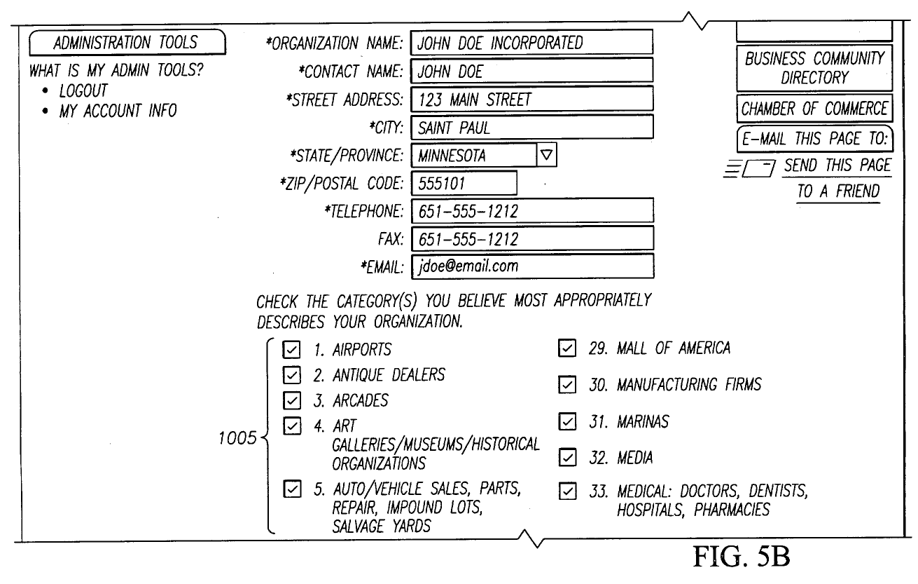

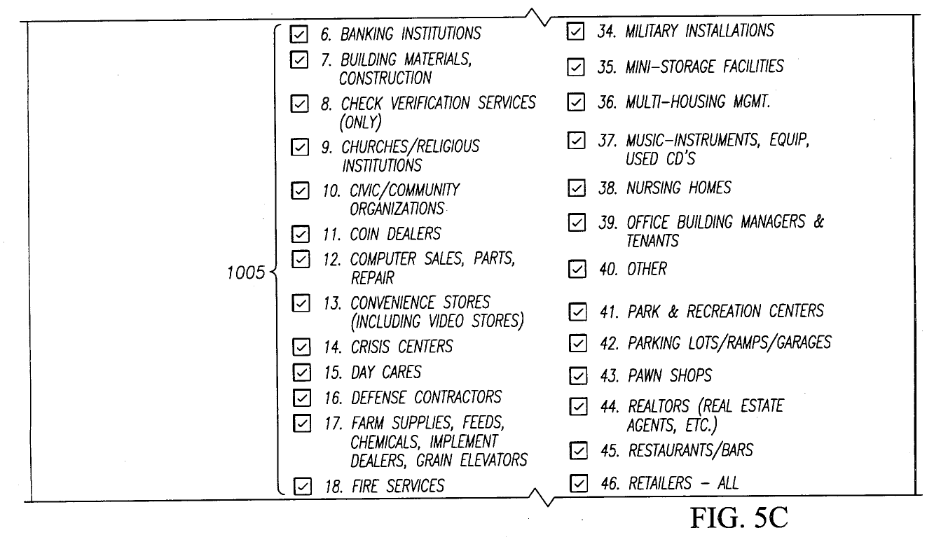

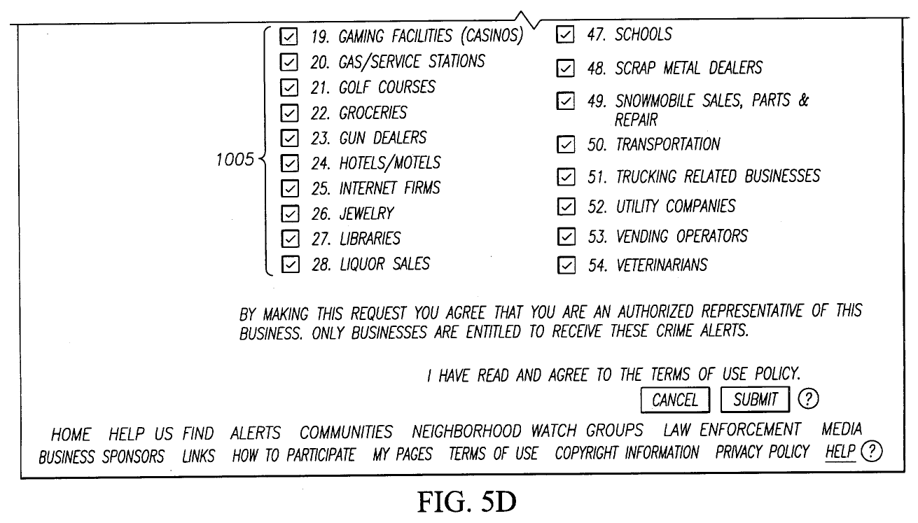

FIGS. 5 through 7 illustrate a webpage template in which a business alert is created. As is shown, many of the fields are the same as in the template for the crime alert. There is a field for the headline 305, page names 310 and 315, an indication on whether the information is public 330, details about the issue 320, an expiration date 325, geographic location information 335, photo functionality 405, suspect description 410, contact information 415 and related links 420.

The embodiment of the business alert shown in FIGS. 5 through 7 also includes fields whereby the sender can determine a geographic coverage area based on a radial distance 505. Since business alerts may be pertinent only to certain types of businesses, the template allows the sender to choose business categories to which the alert should be sent 510. The sender may also indicate whether his/her notification will be displayed when the information is viewed from the database 515 and whether the information is for law enforcement officers only 605. When the notification message is stored to the database, it may be associated with a security level. This security level can be used in many ways, including to determine who has access to view the information, who may edit the information, etc.

FIG. 13 illustrates data entered for a business alert, using a variation of the template shown in FIGS. 5 through 7. In one embodiment of the invention, crime alerts and business alerts are two of many types of notifications supported. Other types of notification messages may be: affinity group alert, community crime alert, community information message, community safety tip, advocate notice, neighborhood watch alert, neighborhood watch group notice, fugitive information message, missing person information message, unsolved crime information, school message, neighborhood message, seniors message, health message, terrorism message and safety message (which may be for public safety or some other classification of safety). Of course, other categorizations of information types may be used.

Returning now to FIG. 16, a title of “Theft by Fraud” has been entered 305 and the page name is determined to be “Business Fraud Alert” 310/315. The title is the “Headline” for the notification. When the notification is sent to the receiver, the title is the first piece of information they see. The page name is how the notification is identified in the database. Details of the crime have been entered by the sender 320 and the suspect's photo has been included 405. The template indicates that the sender wants the alert sent to recipients within a five mile radius 505 and that only businesses such as airports, antique dealers, arcades, etc. should receive the alert 510. In other embodiments of the invention, the sender may utilize a map to sketch the geographic area that should limit the distribution of the message. While in some embodiments entering the geographic scope or descriptor is a separate feature of the system, in other embodiments, geographic limitations may be handled through defining and using receiver groups.

FIG. 14 illustrates how such information may display as a distributed message or by being retrieved from the system's database of alerts. Here the information that was entered via the template is shown as a cohesive alert with all critical information arranged in a useful manner.

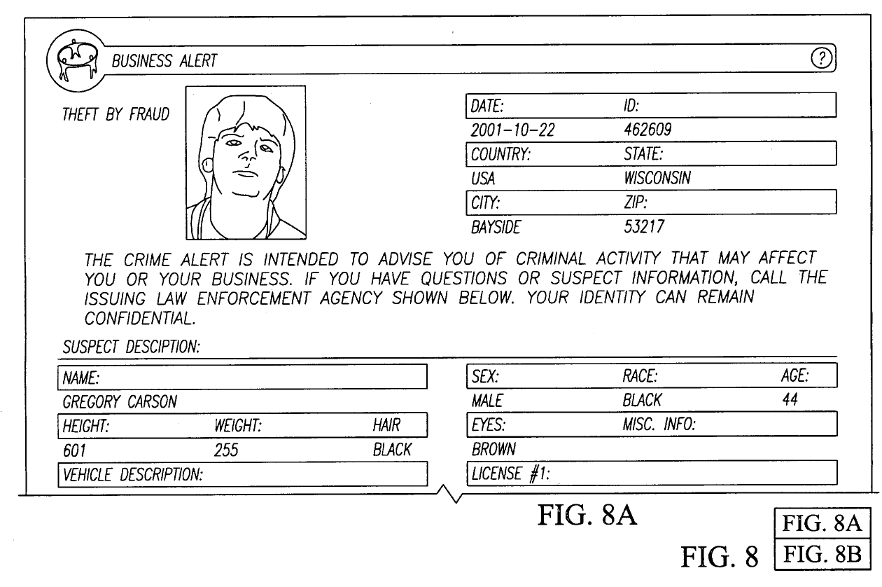

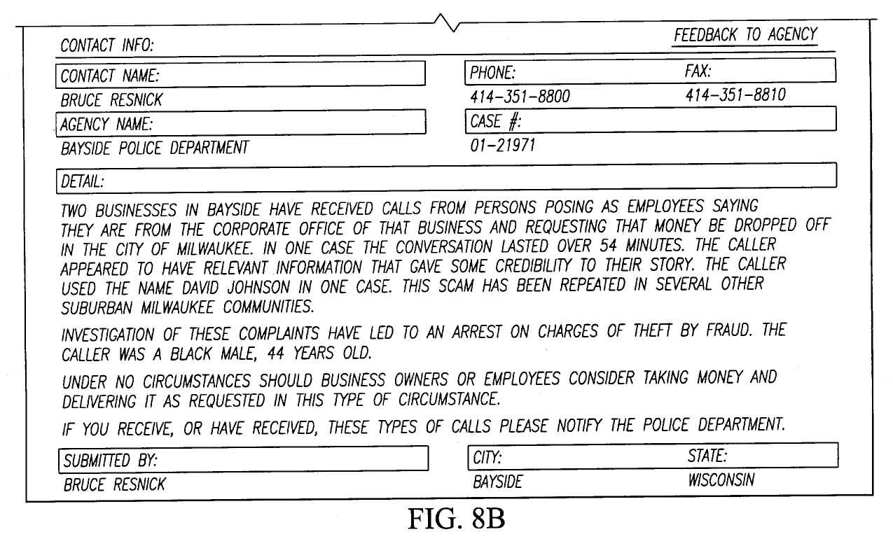

FIGS. 8 through 11 illustrate a how individuals and/or businesses may register with the system. To sign up, the person enters general information 805, such as name and address. Then login information is entered 810, including an email address, password, and message board alias. If the person is affiliated with a law enforcement agency, he or she may enter a badge number 815. This will enable them to be reviewed and potentially granted rights such as being able to submit and distribute crime alerts. If the person represents a business, then he/she can request to receive business crime alerts 820. Otherwise, the person can request the types of alerts to receive 825. While not shown here, users of the system can be enrolled by others than themselves or the Sender. For example, Chamber of Commerce organizations and other affinity groups can provide lists that can be enrolled without the assistance of the newly added user. The user is then notified by one of the communication channels of his new status in the System.

As FIG. 9 shows, the person can then personalize his/her registration to indicate one or more preferred communication channels 905, such as email, fax, telephone, cell phone, wireless PDA, text message, Internet webpage, and mail. This enables the system to send the person alerts in the form most convenient to the registrant. Some recipients may even choose to receive messages in multiple formats. However, some embodiments of the invention allow the sender to choose only certain communication channels, regardless of the receivers' preferences. Some senders may choose to send the message only to the system's database so that it is retrievable by certain users.

FIGS. 10 and 11 show the additional information entered when a business registers. This includes fields that designate the categories that apply to the business 1005. After the business requests registration and is approved, business alerts may be directed to these various business categories. Such self-enrollment by the receiver into one or more receiver groups eases administration of the system. However, in some embodiments, system administrators may reject and self-enrolled users to prevent misuse of the system. In some embodiments, the sender of a notification message may review and prohibit the message from being sent to anyone who was not enrolled by the sender himself. In such an embodiment, the sender sends an approval or rejection to the system for such self-enrolled receivers.

FIG. 12 is a block diagram of one technical architecture for the invention. As shown, users may connect to the system by using various client devices 1205, such as a PC, PDA, digital cell phone, etc. A network 1210, which may be the Internet, an intranet, a WAN, etc. is used to connect to a web server 1220 upon which program code segments 1225 contain the business logic of the system. The alerts and other notification messages are stored on a database 1215 and are accessible by the server 1220. One skilled in the art will recognize that any number of off-the-shelf hardware and software components can be utilized to create such an architecture. The business logic can be programmed using C++, C#, Java, or other programming language. The database 1215 can be one provided by Oracle Corporation, for example and accessed via standard SQL statements.

While the network 1210 may be the Internet, certain embodiments of the present invention are well suited for intranet or WAN implementation. Such a system would allow notification messages to be distributed to a smaller community of users, such as in a large corporation, a law enforcement agency's various branch offices, etc. While the earlier figures have shown the notification messages to be crime or crime prevention related, the notification messages can also be directed to other purposes, such as notifying corporate users of policy changes, deadlines, and the like. The features of limiting messages to a certain geographic area and/or to a certain category of users is well suited to a multi-national corporation that maintains its own secure intranet or WAN.

There are other functions that certain embodiments of the invention provide. One such feature is the ability to distribute notification messages as news releases to various media contacts. This distribution may be automatically repeated after a determined amount of time in order to remind the media of the unsolved crime, missing person, fugitive, etc. This function may be extended to sending such automated messages to first responders, schools, neighborhood groups and the like.

In another embodiment, when a receiver receives a notification message, he or she is presented the opportunity to respond directly to the sender rather than to an administrator of the system. This ensures that important information is provided to law enforcement in a timely manner.

As an additional security feature, one embodiment of the invention checks the authorization of the sender before publishing his or her notification message.

The foregoing description addresses embodiments encompassing the principles of the present invention. The embodiments may be changed, modified and/or implemented using various types of arrangements. Those skilled in the art will readily recognize various modifications and changes that may be made to the invention without strictly following the exemplary embodiments and applications illustrated and described herein, and without departing from the scope of the invention, which is set forth in the following claims.

What is claimed is:

1. A method for a sender to distribute messages to a receiver, the method comprising:
determining a notification type;
composing a notification message in accordance with the notification type;
choosing zero or more categorized receiver groups;
determining zero or more communication channels; and
publishing the notification message via the zero or more communication channels to members of the zero or more receiver groups who are within the chosen coverage area;
wherein the notification message is directed to a safety concern.

2. The method from claim 1, wherein the communication channels are selected from the group consisting of email, fax, telephone, cell phone, wireless PDA, text message, Internet webpage, database, chat, teleconference and mail.

3. The method from claim 1, wherein the categorized receiver groups are selected from the group consisting of sender enrolled, sender approved, sender allowed, self enrolled, group enrolled, third party enrolled.

4. The method from claim 1, further comprising choosing a geographic coverage area.

5. The method from claim 1, wherein the geographic coverage area is based on a distance from a focal location.

6. The method from claim 1, wherein the step of storing the notification message comprises:
determining a security level for the notification message; and
saving the notification message to a database with the associated security level.

7. The method from claim 1, wherein the notification type is one or more selected from the group consisting of business alert notice, affinity group alert, community crime alert, community information message, community safety tip, advocate notice, neighborhood watch group information, neighborhood watch alert, neighborhood watch group notice, fugitive information message, missing person information message, unsolved crime information message, school information, seniors information, health information, terrorism information, and public safety information.

8. The method from claim 1, wherein the step of determining the zero or more communication channels is determined by the sender.

9. The method from claim 1, wherein the step of determining the zero or more communication channels is determined by the receiver.

10. The method from claim 1, further comprising self-enrolling a receiver to one or more receiver groups.

11. The method from claim 1, further comprising:
allowing a sender to review and to prohibit the notification message from being sent to any receiver who was not enrolled by the sender; and
receiving from the sender an approval or rejection regarding the self-enrollment by the receiver.

12. The method from claim 1, further comprising sending the notification message to one or more media contacts as a new release.

13. The method from claim 1, further comprising automatically re-sending the notification message to the Sender or Receiver after a predetermined period of time has elapsed.

14. The method from claim 1, further comprising adding a link within the notification message to a website.

15. The method from claim 14, wherein the website is maintained by a crime advocate of an unsolved crime of an open police file.

16. The method from claim 1, further comprising the step of authenticating the notification message by retrieving corroborating information from a database.

17. The method from claim 1, further comprising offering the receiver to respond directly to the sender of the notification message.

18. The method from claim 1, further comprising verifying the authorization of the sender before publishing the notification message.

19. The method from claim 1, wherein the step of determining the zero or more communication channels is determined by the sender and comprises choosing a plurality of communication channels for the same receiver group, for providing multiple notices to the receiver.

20. The method from claim 1, wherein the step of determining the zero or more communication channels is determined by the receiver and comprises choosing a plurality of communication channels for the same receiver group, for providing multiple notices to the receiver.

21. The method from claim 1, wherein the geographic coverage area is determined by a visual indication on a displayed map.

22. The method from claim 14, wherein the website is maintained by a neighborhood watch group.

23. The method from claim 1, wherein the receiver is a website.

24. The method from claim 1, further comprising defining a new geographic coverage area.

25. The method from claim 1, further comprising sending the notification message concerning public safety to one or more media contacts, first responders to emergencies, schools, or businesses.

26. The method from claim 14, wherein the sponsor of the website is explicitly authorized by the sender.

27. The method from claim 1, further comprising storing the notification message in a database.

28. The method from claim 1, wherein the coverage area is chosen based on a geographic descriptor.

29. The method from claim 1, wherein the coverage area is implemented as one of the receiver groups.
